(19) United States
(12) Patent Application Publication
(10) Pub. No.: US 2009/0040024 A1
(43) Pub. Date: Feb. 12, 2009

(54) ASSEMBLY DEVICE WITH AN ASSEMBLY CONTROL SYSTEM

(75) Inventors: Mohieddine Boubtane, Seyssinet-Pariset (FR); Jean-Jacques Legat, Colombe (FR)

Correspondence Address: BAKER & DANIELS LLP;111 E. WAYNE STREET, SUITE 800, FORT WAYNE, IN, 46802, US

(73) Assignee: A. RAYMOND ET CIE, Grenoble (FR)

(21) Appl. No.: 12/162,730

(22) PCT Filed: Jan. 25, 2007
(86) PCT No.: PCT/EP2007/000622

§ 371 Date: Jul. 30, 2008

(30) Foreign Application Priority Data
Feb. 28, 2006 (FR) 06/01786

(51) Int. Cl. H04Q 5/22

(52) U.S. Cl. 340/10.1

(57) ABSTRACT

A device for assembling two constructional elements is equipped with an assembly control system (CR) comprising a sensor (26) for measuring a physical assembly control parameter and a radiofrequency label (14) communicating with said measuring sensor (26). The control system (CR) is capable of determining a characteristic curve representative of the change in the physical control parameter during the assembly of the two constructional elements. The radiofrequency label (14) is capable of transmitting a control signal (SC) representative of said characteristic curve to a control unit (31) situated remotely for comparison with a predetermined specific curve.

### CROSS-REFERENCE TO RELATED APPLICATION

This application is a U.S. National Phase Patent Application based on International Application Serial No. PCT/EP2007/000622 filed Jan. 25, 2007, the disclosure of which is hereby explicitly incorporated by reference herein.

### BACKGROUND OF THE INVENTION

1. Field of the Invention

The present invention concerns an assembly device for assembling two structural elements, the assembly device being equipped with an assembly control system including a measuring sensor for measuring a physical parameter serving to verify assembly and a radio frequency tag communicating with the measuring sensor.

2. Description of the Related Art

The measuring sensors currently used in the control systems integrated into assembly devices operate on a binary principle, i.e. an all or nothing principle. These control systems operate to determine remotely whether the measuring sensor is in the activated or inactivated state.

Depending on the arrangement of the device itself and the operation of the integrated control system, the state of the sensor sometimes cannot be used to determine with certainty whether or not the assembly device is in the assembled state. For example, with many known assembly devices, it is possible for the measuring sensor to change states even though the device is not in the assembled state.

Furthermore, such measuring sensors cannot be used to qualitatively control the assembly performed. In many known applications, it is possible for assembly to be poorly executed (for example, due to failure to satisfy mounting conditions) without this being detectable by the control system. In such a case, the measuring sensor does change states at the time of assembly, and the control system shows that assembly has been completed. But the risk remains that the device will subsequently deteriorate with time, or even fall apart, due to poor mounting conditions.

### SUMMARY OF THE INVENTION

The present invention provides improved control of the assembly performed by assembly devices designed to assemble two structural elements.

According to the invention, this aim is achieved by the fact that the control system is capable of determining a characteristic curve representative of the change in the verifying physical parameter at the time of the assembly of the two structural elements, and in that the radio frequency tag is capable of transmitting a control signal representative of said characteristic curve to an external control unit for comparison with a predetermined specific curve.

The predetermined specific curve recorded in the control unit is established for assembly conditions that correspond to normal assembly satisfying all the anticipated requirements. With a control system according to the invention, therefore, when the comparison between the predetermined specific curve and the characteristic curve received is positive, it can be concluded with certainty that the device is in the assembled state and that assembly has been qualitatively well executed.

In one form thereof, the present invention provides an assembly device for assembling two structural elements, the assembly device being equipped with a control system (CR) for verifying assembly, including a measuring sensor for measuring a physical parameter serving to verify assembly and a radio frequency tag communicating with the measuring sensor, characterized in that the control system (CR) is capable of determining a characteristic curve representative of the change in the physical parameter at the time of assembly of the two structural elements, and in that the radio frequency tag is capable of transmitting a control signal (SC) representative of the characteristic curve to an external control unit for comparison with a predetermined specific curve.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a front view of a first embodiment of the assembly device according to the invention;

FIG. 2 is an exploded perspective view of the assembly device of FIG. 1;

FIG. 3 is a perspective view of the lower portion of the device of FIG. 1;

FIG. 4 is a schematic representation of an exemplary control system that can be used in the assembly device of FIG. 1;

FIG. 5 is a perspective view of a second embodiment of the assembly device according to the invention;

FIG. 6 is an exploded perspective view from below of the assembly device of FIG. 5; and

FIG. 7 is a perspective view of a longitudinal section of the assembly device of FIG. 5.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

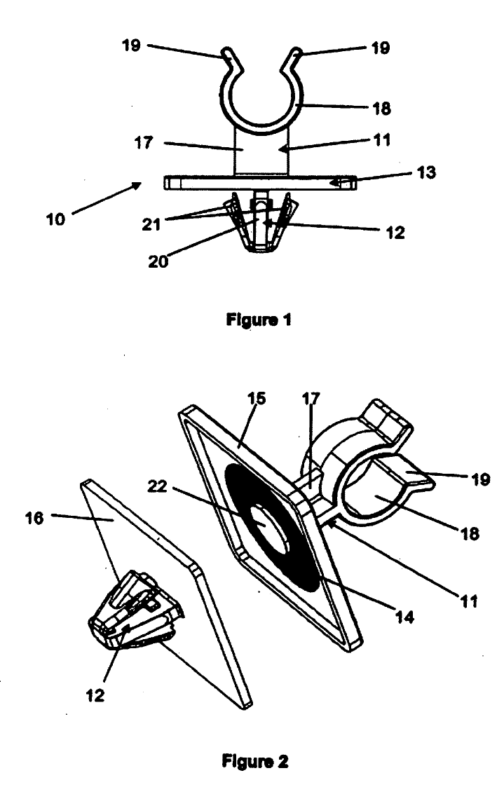

FIGS. 1 to 3 illustrate a first embodiment of the assembly device according to the invention. The assembly device, referenced 10, is elongate in shape and is designed for assembling a tube on a support (neither of which is shown), with an upper portion 11 to which the tube is to be mated and a lower portion 12 for fixing the assembly device 10 on the support. In the variant shown, the upper and lower portions 11 and 12 are constituted by two one-piece plastic assemblies, which are rendered integral to each other in the central region of the assembly device 10.

The central region of the assembly device 10 forms a rectangular case 13 of small thickness, designed to accommodate a annular radio frequency tag 14. The case 13 is composed of a rectangular lid 15 belonging to upper portion 11 and a plate 16 complementary in shape to said lid 15 and belonging to lower portion 12.

Extending from the external surface of the lid 15 is a holding element 17 of a clip ring 18 of the tube. The clip ring 18 is in the shape of a deformable C, with the opening directed upward. The holding element 17 has an X-shaped cross section for good rigidity. The ends of the clip ring 18 support converging guide fins 19, which facilitate placing the tube in the clip ring 18 when the two are being mated together.

Extending from the external surface of the plate 16 is a support web 20 carrying two flexible catches 21 serving to secure lower portion 12 on the support. The flexible catches 21 extend from the distal end of support web 20 in the direction of plate 16. When support web 20 is inserted in a corresponding hole provided in the support, the flexible catches 21 gradually fold up against the support web 20. When the flexible catches 21 are released, they go back to their initial configuration by elastic return, thus effecting longitudinal retention of the support between the flexible catches 21 and the plate 16.

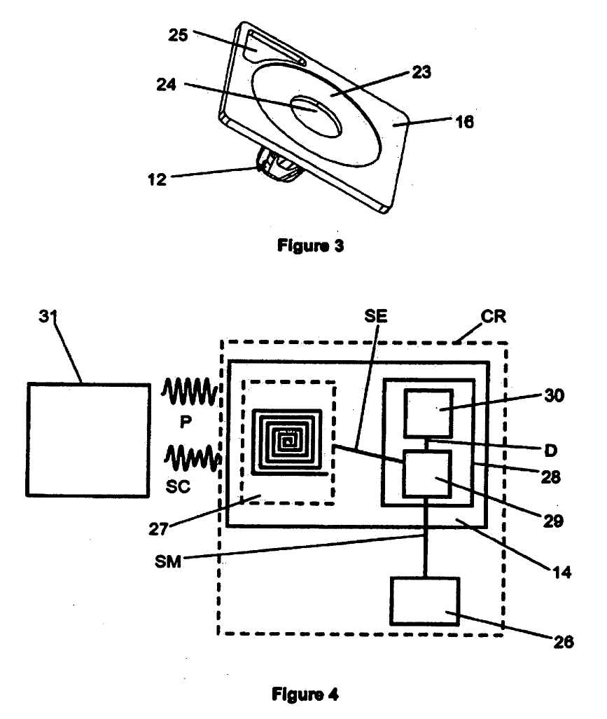

Plate 16 is secured in lid 15 by any appropriate means, for example by adhesive bonding, welding or clipping. In other variants, lower portion 12 is potted onto lid 15. A cylindrically shaped centering element 22 is provided inside the lid 15 to effect transverse retention of the radio frequency tag 14. The latter is placed in the lid 15 before lower portion 12 is secured. In complementary fashion, and in reference to FIG. 3, plate 16 comprises a cylindrically shaped main recess 23 to accommodate radio frequency tag 14. Provided coaxially in the bottom of main recess 23 is a secondary recess 24 that is designed to receive centering element 22 during the securing of upper and lower portions 11 and 12 by the seating of plate 16 in lid 15.

An additional recess 25 is provided in one of the corners of plate 16, on the periphery of main recess 23. Said additional recess 25 serves to accommodate an acceleration sensor (not shown in FIG. 3) whose function will be detailed later on. The acceleration sensor and the radio frequency tag 14 thus are integrated in the assembly device 10.

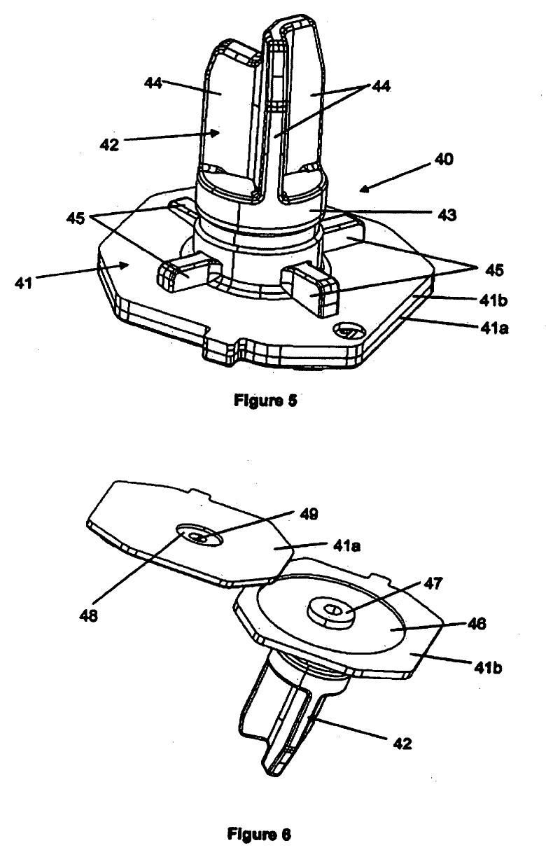

As illustrated schematically in FIG. 4, the acceleration sensor, which is referenced 26 in that figure and which is designed in practice to be seated in additional recess 25, is connected to the radio frequency tag 14, which is, for example, a passive tag. Radio frequency tag 14 has an antenna 27 tuned to a predetermined frequency and connected to a chip 28 that contains an individual identification code ID. The acceleration sensor 26 is connected to a microprocessor 29 of the chip 28. The chip 28 further comprises a memory 30 connected to the microprocessor 29. The acceleration sensor 26 associated with the radio frequency tag 14 constitutes a control system CR integrated into the assembly device 10.

In a known manner, a carrier signal P received by the antenna 27 of radio frequency tag 14 generally serves simultaneously as an interrogation signal and a power supply signal for the radio frequency tag 14. The latter thereupon sends back a carrier signal, designated hereinafter as control signal SC, for example amplitude-modulated by its ID code.

The carrier signal P is emitted by a control unit 31 external to the control system CR and situated remotely from the assembly device 10. In the variant embodiment described, to enable it to communicate by radio frequency with radio frequency tag 14 integral to assembly device 10, control unit 31 comprises an electronic processing unit, which is preferably microprocessor-equipped and is connected to a memory, to an antenna via a transmission/reception interface, and to a man-machine interface. The man-machine interface of the control unit 31 can include a keyboard, a display screen and/or a speaker. The control signal SC emitted by the antenna 27 of the radio frequency tag 14 is adapted to be received by the antenna of the control unit 31.

In practice, the assembly of the tube on the support by means of the assembly device 10 is generally carried out in an area where communication between the radio frequency tag 14 and the control unit 31 is possible. The radio frequency tag 14 and the acceleration sensor 26 are supplied with power via the carrier signal P. At the time of assembly of the tube or the support respectively on the upper 11 and lower 12 portions of the assembly device 10, the acceleration sensor 26 measures the internal vibrations of the assembly device 10. At the time of assembly, the acceleration sensor 26 transmits a measurement signal SM to the microprocessor 29. The latter generates uses the measurement signal SM to generate in real time a characteristic curve representative of the change in acceleration measured by the acceleration sensor 26 during assembly. The microprocessor 29 then generates an excitation signal SE for the antenna 27 that is representative of the characteristic curve generated. From the excitation signal SE, the antenna 27 of the radio frequency tag 14 generates a control signal SC representative of the characteristic curve generated by the microprocessor 29. The control signal SC is received by the control unit 31, which by virtue of its processing unit is able to run a comparison between the characteristic curve generated by the control system CR during the assembly of the tube and the support and a predetermined specific curve recorded in the memory of the control unit 31. The predetermined specific curve is established ahead of time for assembly conditions that correspond to normal assembly satisfying all the anticipated requirements. After being processed by the microprocessor of the control unit 31, the result of the comparison is indicated to the operator by means of the man-machine interface and/or is recorded in the memory of the control unit 31.

When the result of the comparison of the predetermined specific curve and the received characteristic curve run by the processing unit of the control unit 31 is positive, it can be concluded with certainty that the assembly device 10 is in the assembled state and that assembly has been qualitatively well executed. If the result is negative, on the other hand, can be concluded that assembly has not been performed or has not been qualitatively well executed, even though the assembly device 10 is in the assembled state, and, in this case the type of mounting defect can be evaluated (excessive mounting, insufficient mounting, etc.).

In practice, the assembly of the tube on the support by means of the assembly device 10 may also be carried out in an area where there is no provision for communication between the radio frequency tag 14 and the control unit 31. In that case, the control system CR includes an integrated power source to power the radio frequency tag 14 and the acceleration sensor 26. For example, the power source can be integrated into the radio frequency tag 14, which is then a semi-active tag. In other variants, the power source is external to the radio frequency tag 14 and is delivered to the latter for example via antenna 27 or a second antenna (not shown) provided in the radio frequency tag 14 and tuned to a second predetermined frequency.

In that variant, at the time of assembly of the tube or the support respectively on the upper 11 and lower 12 portions of the assembly device 10, the microprocessor 29 uses the measurement signal SM from the acceleration sensor 26 to generate in real time a characteristic curve representative of the change in the measured acceleration. The microprocessor 29 generates and then transfers them to memory 30 data D that are representative of said generated characteristic curve.

In a subsequent phase, once the assembly device 10 has been placed in an area where communication between the radio frequency tag 14 and the control unit 31 is possible and the carrier signal P is being emitted by the control unit 31 and received by the antenna 27, carrier signal P serves solely as an interrogation signal. From carrier signal P, the microprocessor 29 generates, on the basis of the data D stored in memory 30, an excitation signal SE representative of the characteristic curve that was generated in advance. From the excitation signal SE, the antenna 27 of the radio frequency tag 14 generates a control signal SC representative of said characteristic curve. The control signal SC is received by the control unit 31, which then functions in the manner described hereinabove.

In some variants, the acceleration sensor 26 communicates by radio frequency with the chip 28 of the radio frequency tag 14 via antenna 27 or a third antenna (not shown) provided in the radio frequency tag 14 and tuned to a third predetermined frequency.

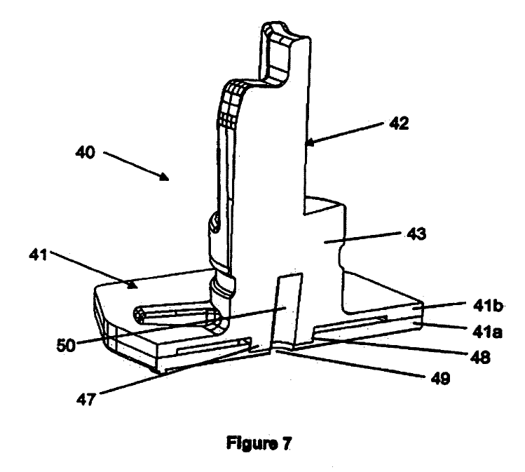

FIGS. 5 to 7 illustrate a second embodiment of the assembly device according to the invention. The assembly device, referenced 40, comprises a base 41 designed to be bonded to a support (not shown), from which extends an elongate body 42 that is to be forcibly mated with a sleeve (not shown) provided on a structural element to be assembled with the support. In the variant shown, base 41 has a small thickness and is constituted by a bonded assemblage of a lower base portion 41a and an upper base portion 41b. The bottom face of lower base portion 41a is designed to be bonded to the support and its top face is designed to be integrally fixed against the bottom face of upper base portion 41b. The elongate body extends from the top face of upper base portion 41b, forming an angle that is slightly inclined from the true perpendicular. The value of the inclined angle depends on the relative arrangement of the support and of the sleeve of the structural element that is to be assembled with the support.

The elongate body 42 is constituted by a cylindrical portion 43 rising from the top face of upper base portion 41b and by a plurality of radial fins 44 (three in number, in the example shown) extending axially in the prolongation of the cylindrical portion 43. Abutment ribs 45 rise between the top face of upper base portion 41b and the base of cylindrical portion 43 to constitute an abutment during the forcible mating of the sleeve. The height of the abutment ribs 45 is adapted, depending on their locations, to compensate for the angle of inclination of elongate body 42.

In FIG. 6, lower base portion 41a is inverted from its use position, i.e. the position it has after being bonded against the bottom face of upper base 41b. In reference to FIG. 6, the bottom face of the upper base 41b has an annular recess 46 designed to accommodate the radio frequency tag 14 of the previously described assembly device 10. Transverse retention of the radio frequency tag 14 in the annular recess 46 is effected by a cylindrically shaped centering element 47 provided at the center. Radio frequency tag 14 is placed in annular recess 46 before lower base portion 41a is secured.

In complementary fashion, the top face of lower base 41a comprises a cylindrically shaped main recess 48 designed to receive centering element 47 during the securing of lower and upper base portions 41a, 41b. A hole 49 opening onto the bottom face of lower base 41a is provided in the center of the bottom of main recess 48.

In addition, a cavity 50 of elongate shape is provided in the material of cylindrical portion 43, and extends from the center of centering element 47. The axis of orientation of the cavity 50 is orthogonal to the plane of the base 41. The opening of the cavity 50 coincides with hole 49, such that the cavity 50 communicates with the outside when lower and upper base portions 41a, 41b are secured to each other. The cavity 50 is designed to accommodate a temperature sensor (not shown), whose function will be detailed later on.

More precisely, the assembly device 40 integrates a control system CR identical to that integrated in the assembly device 10, with the difference that the acceleration sensor 26 is replaced by the aforementioned temperature sensor. The latter is designed to measure the temperature in proximity to the opening of the hole 49 at the time of the bonding of the bottom face of lower base portion 41a to the support.

In practice, at the time of the assembly of the structural element with the support, the microprocessor 29 generates a characteristic curve representative of the change in temperature measured by the temperature sensor during the bonding of the bottom face of lower base portion 41a to the support. Said characteristic curve is transmitted, in real time or subsequently, depending on the application, to the control unit 31 so that a comparison can be made with a predetermined specific curve. The result of this comparison can be used to verify that assembly has been carried out and to assess the quality of the assembly executed.

Finally, the invention can be applied to any assembly device for assembling two structural elements, with which it is possible at the time of assembly to measure a physical parameter serving to verify assembly. The measuring sensors used in integrated control systems CR can be of the following types, for example: pressure sensor, force sensor, torque sensor, optical sensor, moisture sensor, solar energy sensor, piezoelectric sensor. Moreover, depending on the variants and needs, the measuring sensor, rather than being integrated, can be situated in proximity to the parts per se of the device that are to be assembled. The control system CR is then semi-integrated.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-9. (canceled)

10. An assembly device for use in assembling two structural elements, said assembly device comprising:
a control system (CR) for verifying assembly, said control system including a measuring sensor measuring a physical parameter serving to verify assembly and a radio frequency tag communicating with said measuring sensor, said control system (CR) determining a characteristic curve representative of the change in said physical parameter at a time of assembly of said two structural elements, and said radio frequency tag transmitting a control signal (SC) representative of said characteristic curve to an external control unit for comparison with a predetermined specific curve.

11. The device of claim 10, wherein said radio frequency tag includes at least one individual identification code (ID) contained in a chip connected to an antenna.

12. The device of claim 11, wherein said measuring sensor is connected to said chip of said radio frequency tag.

13. The device of claim 11, wherein said measuring sensor communicates with said chip via an antenna of said radio frequency tag.

14. The device of claim 10, wherein said control system (CR) further comprises an integrated power source.

15. The device of claim 11, wherein at said time of assembly, said measuring sensor transmits a measurement signal (SM) to a microprocessor integrated in said chip of said radio frequency tag to generate said characteristic curve.

16. The device of claim 15, wherein data (D) representative of said characteristic curve are generated by said microprocessor and transmitted to a memory integrated in said chip.

17. The device of claim 15, wherein said microprocessor generates an excitation signal (SE) of said antenna of said radio frequency tag, said excitation signal (SE) representative of the characteristic curve generated.

18. The device of claim 17, wherein said control signal (SC) is representative of said excitation signal (SE) of said antenna of said radio frequency tag and is transmitted by said antenna.
